(19) United States
(12) Patent Application Publication
(10) Pub. No.: US 2001/0046196 A1
(43) Pub. Date: Nov. 29, 2001

(54) METHOD AND APPARATUS FOR AUTOMATICALLY ADJUSTING THE SPEED OF A ROTATING MEDIUM TO ENHANCE READING CAPABILITIES

(76) Inventor: THOMAS W. MCKERNAN, FORT COLLINS, CO (US)

Correspondence Address: LSI Logic Corporation, 1551 McCarthy Blvd., M/S: D-106 Patent Department, Milpitas, CA, 95035, US

(21) Appl. No.: 09/041,230

(22) Filed: Mar. 12, 1998

(51) Int. Cl. G11B 7/00

(52) U.S. Cl. 369/53.35

(57) ABSTRACT

A method and an apparatus for reading information from a rotating storage medium allows data to be reliably read at high speeds provided the medium meets design specifications. When the rotating storage medium includes significant imperfections which affect the medium's center of mass or otherwise affect its ability to rotate at very high speeds without significant vibration and wobble, the method and apparatus of the present invention allow the imperfect storage medium to be reliably read by at a lower speed. The preferred embodiment of the method detects read errors using the ECC information encoded into the information stored on the rotating storage medium. The method alters the speed the medium in response to the detected read errors. Apparatus is presented which is used to perform the method. The inventive techniques are especially applicable to CD-ROM and DVD technology.

### BACKGROUND OF THE INVENTION

1. Technical Field

This invention relates generally to the accurate retrieval of information stored on rotating storage media such as optical disks. More particularly, the invention relates to the automatic adjustment of the speed of a rotating storage medium to compensate for physical irregularities which may inhibit reading at very high speeds.

2. Description of the Related Art

Various forms of rotating storage media are used to store digital information including data, digitized audio signals, and digitized video image sequences. For example, rotating storage media include optical disks such as CD-ROMs (compact disk read only memories), DVDs (digital video disks), and rotating magnetic disks. Digital information stored on concentric or spiral tracks of a rotating medium are read by a pick-up device while the medium is controlled to rotate at a specified speed. Typically, the medium is controlled to rotate at a constant angular velocity (CAV-control) or at a constant linear velocity (CLV-control).

As exemplified in the CD-ROM industry, as technology evolves, the rotational speed of the rotating media increases so as to allow data to be read at higher and higher rates. For example, the first generation of CD-ROM drives are able to spin the CD-ROM at a rate of 525 rpms (1X). Second generation CD-ROM drives spin the CD-ROM at twice this rate and are thus referred to as 2X drives. Presently, drives speeds of 1X, 2X, 4X, 8X, 12X, 16X and 32X have reached the market and higher speed CD-ROM drives are under development. Also, even higher speed DVDs are being researched and developed. Note that the 16X and 32X dives have spin rates of 8400 rmps and 16800 rpms respectively.

The increased speed of modem CD-ROM drives and other rotating media drives gives rise to a difficult set of physical problems. For example, CD-ROM drives must be designed to read CDs with physical imperfections. These imperfections include thickness or density variations on the physical CD patter due to poor plastic molding or uneven labeling, warping, scratches, or off-center holes. Most of these imperfections may create situations whereby the center of mass of the disk is different from its surface center (imbalanced platter). A disk's vibration or wobble increases in proportion to the rotational speed, and to the radial distance from the axis of rotation to the disk's center of mass. Hence while these imperfections do not create serious difficulties when the disk is rotating at 2X or 4X speeds, these imperfections give rise to much more pronounced vibration and wobble when the media is spinning higher speeds such as 8X, 12X, 16X, or 32X.

The problems associated with reading imperfect disks at high spin rates may be understood in connection with a prior art CD-ROM reading apparatus as taught in U.S. Pat. No. 5,200,944 and as illustrated in FIG. 1. A rotating media 110 with concentric or spiral information tracks is spun by a motor 115. The motor 115 receives control signals from a servo control circuit 120. Data from the rotating media 110 is read by a pick-up 125. The pick-up 125 produces an electronic output signal which is fed into a wave shaping circuit 130. The wave shaping circuit 130 produces an analog output signal which is fed into a slicer and digitizer 135 and to a clock extraction circuit 140. The slicer and digitizer 135 accepts a timing signal from the clock extraction circuit 140. A digital signal is produced at the output of the slicer and digitizer 135, and this digital signal is fed into a digital signal processor (DSP) block 145. The DSP 145 feeds back a control signal to the servo circuit 120 and includes a data path connection to a microprocessor 150. The microprocessor 150 includes a system interface, typically connected to a computer, audio, or video system.

In operation, the disk 110 is spun by the motor 115 so that the disk's concentric or spiral information tracks may be read by the pick-up 125. In typical optical implementations, the pickup 125 illuminates the disk 110 with a laser and detects a reflected signal with a photo diode array. In order to obtain a desirable information signal from the disk, it is important that the laser illuminate the next sequential portion of the information track so as to receive a signal therefrom which is correlated with the desired data stored in the information track. The received signal is routed from the pick-up 125 into the wave shaping circuit 130 which typically provides gain control and filtering to the pick-up output signal. This analog signal is typically sent to a clock extraction circuit which may include a reference oscillator and a phase locked loop. In some embodiments, the clock may be extracted using the output of the slicer and digitizer 135. The clock extraction circuit 140 supplies the timing signal used to determine when to sample the analog signal output from the wave shaper 130 to produce a digital signal for further processing in the DSP 145. The DSP 145 performs demodulation, data formatting, and decoding of ECC (error correction coded) data. The DSP 145 also feeds back a signal used by the servo circuit 130 to control the spin rate of the disk.

When the disk is spun at very high speeds the analog signal produced at the output of the pick-up 125 varies more rapidly and is thus more susceptible to noise. Also, as discussed above, as the disk's spin rate is increased, the amount of vibration and wobble increases due to imperfections on the physical medium also increases. This vibration and wobble inhibits the ability of the laser in the pick-up to precisely illuminate the desired information track and receive information from desired information it. Instead, the laser goes off track and illuminates portions of the disk near the desired information track, but not directly on it. The information signal received by the photo diode array hence contains incorrect signal components which contribute noise into the received signal. As the amount of vibration and wobble in the disk increases, the output signal from the pick-up 125 becomes less correlated with the stored information and hence the error rate of the digital receiver algorithm executed within the DSP 145 increases accordingly. Hence while the high speed drive may be able to read some disks without difficulty, it may not be able to read other disks with more pronounced physical imperfections.

Several approaches have been advanced in the prior art to deal with the problems associated with recovering data from very rapidly rotating storage media. One approach involves checking the error rate of the recovered data by making use of the error correction and detection encoding present in the stored information. When the error rate exceeds a threshold, a re-read is initialized so that multiple attempts to read the data may be made. This approach lowers the average reading speed of the disk. When the amount of vibration and wobble is high, this approach may not even be able to recover the data even with multiple read attempts. Another approach is to increase the agility and control of the laser pick-up to allow it to be properly pointed on the desired information track in the face of severe vibration and wobble. This solution is expensive to implement and will still have a limit to how much vibration and wobble can be tolerated before the reading fails. Mechanical based solutions include building drives with improved chucking and clamping mechanisms that hold the disk in place, and drives with mechanical shock absorbers. Because these systems need to be designed for a worst case scenario, these mechanical sub-systems must be inherently over-engineered and are thus costly. Also, if a disk is encountered that is outside the limits of the worst case scenario, the system will fail.

It would be desirable to have a disk drive architecture that could read most disks at very high speeds, but could also read disks with pronounced imperfections. It would be desirable if the readable rate of a disk could be accurately estimated. This is important, for example in video applications which are sensitive to sporadic delays in the read channel. It would also be desirable to have a low cost drive apparatus that could read most disks at very high speeds while maintaining the ability to read disks with pronounced imperfections. It would be desirable to have a programmable architecture that could be modified under program control. Moreover, it would be desirable to have an architecture that could map the readability of a disk as a radial function so that, for example, the inner tracks with lower levels of vibration could be read at a first optimized rate while the outer tracks with higher levels of vibration could be read at a second optimized rate.

### SUMMARY OF THE INVENTION

The method and apparatus of the present invention solve these and other problems by providing methods and apparatus to adjust the spin rate of a rotating medium in accordance with the readability of the information stored thereon. The medium's readability may be determined by processing the ECC (error correction coding) information embedded in the information tracks of the medium. The method provides a means to optimize the spin rate of the medium based on the error reports generated in the drive's ECC processing circuits. For example, when a high speed drive fails to reliably read a track in a CD-ROM with significant imperfections, a control algorithm analyzes the ECC error levels and sends a command to a servo circuit to reattempt the read at a lower speed. Alternatively, when low error rates are reported by ECC processing, the invention may attempt reads at a higher spin rate. Hence, well-balanced disks may be read at very high speeds, while disks with significant imbalances may be reliably read at lower speeds. This solution avoids the hard failures that arise in many cases with high speed drives attempt to read imperfect media.

The invention solves the prior art problem of high cost by replacing expensive hardware approaches with an inexpensive control algorithm that only requires a firmware modification when applied to the programmable apparatus of the preferred embodiment. Also, the problem ofaverage frequent and multiple re-reads required at high speeds due to vibrating tracks is reduced or eliminated at lower speeds. In cases where a disk's imperfections render it totally unreadable at a higher speed, in all but the most thesevere cases, the present apparatusdesignedpresent will be able to read the information from the disk at a lower speed. Hence, a high speed drive may be optimized for disks meeting a first set of mechanical specifications that will be met by most disks. Disks that do not fall within these specifications may be read at lower speeds. This represents an inexpensive software solution instead of a costly over-engineered hardware solution.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

The various novel features of the invention are illustrated in the figures listed below and described in the detailed description which follows.

FIG. 1 is a block diagram that illustrates processing in a prior art CD-ROM drive system.

FIG. 2 is a block diagram that illustrates an embodiment of a programmable media-read processor designed in accordance with the present invention.

FIG. 3 is a flow chart that illustrates a method of reading information stored on a disk in accordance with the present invention.

FIG. 4 is a flow chart that illustrates a method of altering the speed of a disk when reading a track in accordance with the present invention.

FIG. 5 is a diagram illustrating a radial speed map of a disk according to an aspect of the present invention.

### DETAILED DESCRIPTION

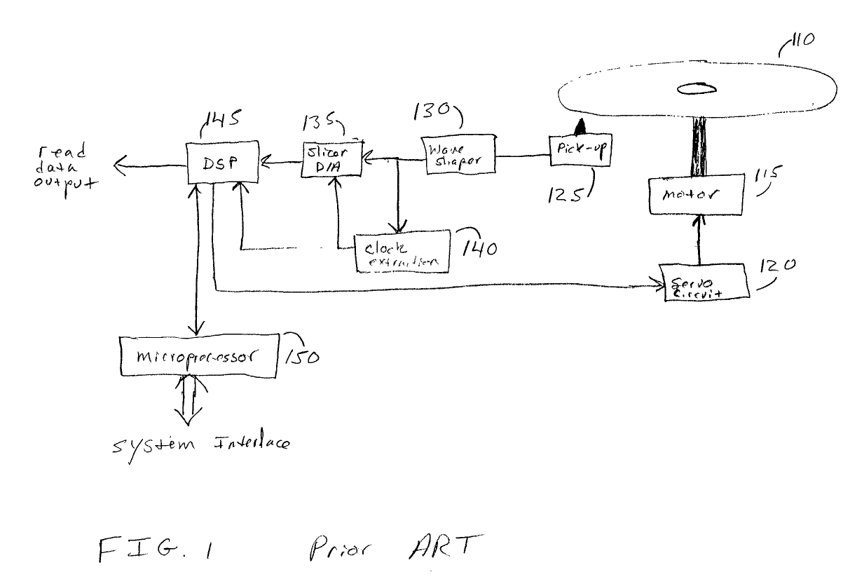

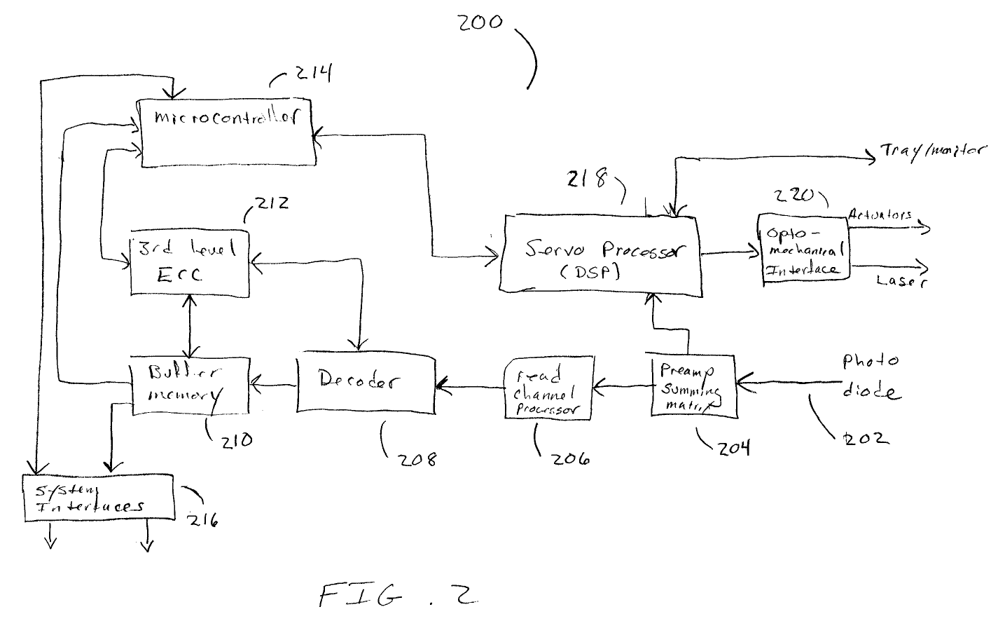

FIG. 2 is a block diagram illustrating a programmable media-read processor 200 designed in accordance with a preferred embodiment the present invention. The electronics of the media-read processor 200 may be implemented on multiple semiconductor chips or may be integrated onto a single die. Similar to the system shown in FIG. 1, the media-read processor 200 typically interfaces to a system host processor, a motor and a pick-up device. While this embodiment focuses on an optical system incorporating a laser for disk illumination and a photo diode receiver, it is to be understood that the invention applies to various forms of media with differing details in the design and implementation. Also, while the discussion focuses on a CD-ROM embodiment, the system is equally applicable to DVD and other systems.

In the preferred embodiment of FIG. 2, a photo diode array (not shown) supplies a photo diode matrix signal consisting of one or more laser diode outputs on line 202 to a preamplifier and summing matrix circuit 204. The preamplifier and summing matrix circuit 204 supplies an RF (radio frequency) output signal to a read channel processor 206 and supplies control information to a servo processor 218. The read channel processor 206 supplies a phase modulated digital signal to a decoder 208. The decoder 208 supplies a digital bit stream to at least one of a buffer memory 210 and an optional third level ECC processor 212. If the optional third level ECC processor is employed, the optional third level ECC processor supplies error reporting output to a microcontroller 214. If the optional third level EEC processor 212 is not employed, then the decoder 208 bypasses EEC block 212 and passes a set of lower level ECC (CIRC) information generated within the decoder 208 to the microcontroller 214. The microcontroller 214 and the buffer memory 210 are both coupled to a system interface block 216 which may include a tray front panel interface, a standardized CD-ROM data path, and an interface to a host processor. The microcontroller 214 is also coupled to a servo processor 218. The servo processor may receive various inputs from the CD-ROM enclosure, for example a tray front panel signal and a monitor diode signal. The servo processor 218 provides output signals to an opto-mechanical interface 220 which provides a set of actuator drive signals for motor control and a laser signal used to illuminate the information track of the disk.

The media-read processor 200 is operable to convert information signals received from a photo diode array into a digital bit stream suitable for use in audio, video, and/or computer systems. The media-read processor 200 is also operable to interact via the servo circuit 218 and the opto-mechanical interface 220 with attached the CD-ROM drive by controlling the spin rate of the disk, the radial location of a laser beam located within the CD-ROM drive, the focusing of the optical signals, and the like. Hence the media-read processor's main functions are processing the information reflected from the disk, and controlling the disk drive itself to provide the proper photo diode input signal.

The photo diode array signal which enters the system at the input line 202 preferably includes four individual photo diode signals. These four signals are generated in the pick-up (see block 125 in FIG. 1) which preferably includes a planar array of four photo diodes. The presence of four photo diodes arranged in a planar array provides directional information used by the servo processor to keep the received laser signal focused into the center of the planar array. The preamplifier and summing matrix block 204 sums the four photo-diode signals from input line 202 to provide an RF output signal which contains phase modulated, analog information. This RF output signal is supplied to the read channel processor 206. Also, the preamplifier and summing matrix 204 sends the directional information to the servo processor 218 which uses this information to keep the laser beam focused in the center of the photo-diode receive array. The read channel processor 206 preferably includes a cascade of a high pass filter, an AGC (automatic gain control) amplifier, a slicer/digitizer, and a clock recovery circuit. The read channel processor 206 delivers a digital bit stream with associated clocking signals to the decoder 208.

The decoder 208 preferably performs multiple functions. First, it analyzes the input information stream and looks for a frame level synchronization signal. Also, as per the standard CD-ROM information stream format, the decoder strips off the added synchronization and merger bit fields embedded within the bit stream. Next it performs EFM (fourteen to eight bit) demodulation. EFM demodulation reduces a frame of 14-bit code to a frame of 8-bit code (bytes) creating a F₃ frame. The decoder then strips out subcode information and sent for subcode processing. Next the decoder performs 2 level CIRC (cross interleaved Reed-Solomon) decoding on a 32-byte F₂ frame, passing the frame through a error correction (C1)/de-interleaved/error correction (C2) process to generate complete, corrected 24-byte F₁ frames. Both the EFM and CIRC operations occur at the frame level of the information hierarchy. In audio applications, the CIRC decoded bit stream is the final output and is sent to the buffer memory 210 to be interfaced to the host or media player device via a system interface 216. In data applications, the CIRC-decoded data is byte-swapped, descrambled, sector-formatted and sent to the third level EEC block 212. The third level ECC occurs at the sector level of the information hierarchy. The final sector-formatted bit stream is sent to the buffer memory 210 to be interfaced via a system interface 216 to the host system.

The various ECC decoding operations generate information, indicating the error level in the decoded bit stream. Depending on the implementation, information from any or all of these ECC levels may be forwarded to the microcontroller 214 which executes the media-read processor 200's control algorithms. In accordance with a preferred embodiment of the present invention, the microcontroller 214 includes control algorithms that monitor the error levels as reported by selected ECC decoding operations. Based on these reported error levels, the microcontroller may send various types of commands to the servo processor 218. For example, the microcontroller may send a re-read signal to command the servo to attempt to re-read the same track at the same speed. Alternatively, the microcontroller may command the servo to reread the track at a higher or lower speed. The microcontroller 214 preferably executes ROM-coded algorithms with associated flow diagrams that allow the processor to learn and remember characteristics of the disk currently in the drive and to send speed oriented commands to the servo processor 218. In some embodiments the microcontroller may be implemented as a hardwired state machine. The servo processor 218 executes servo control algorithms as are known in the art for example to spin the disk at specified speed, to position the laser in track-seek operations, and to focus the laser. The opto-mechanical interface 220 is used to generate actuator drive currents for the motors within the disk drive and to turn the laser on and off.

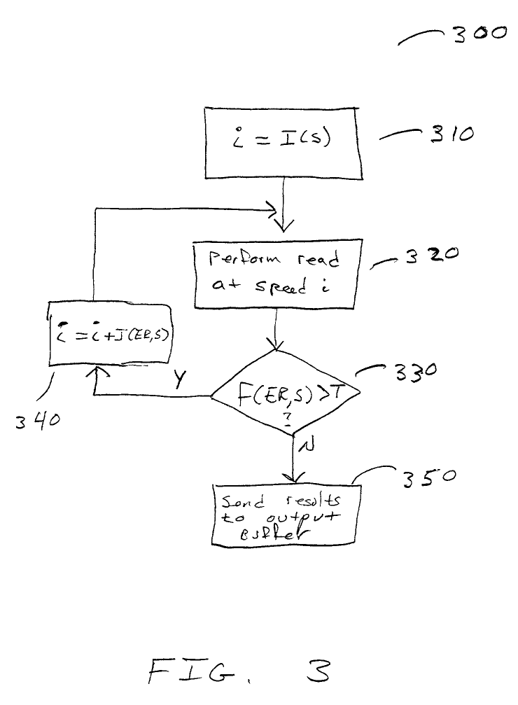

FIG. 3 is a flowchart that illustrates a method 300 for reading information stored on a disk in accordance with the present invention. In the preferred embodiment, the method 300 is a portion of an overall control algorithm executed by the microcontroller 214. This method will be discussed in connection with the preferred embodiment of the media-read processor 200, but could be applied to other types of media-read (or media-read/write) processors as well. In the first step 310 of the method, a speed parameter i is initialized according to a function i=I(S) where I is an initialization function. The argument of this function, S, corresponds to a set of one or more state variables maintained in the system. For example, the variable S may correspond to the radial position of the laser on the media and any other history related information that may be used to set an initial speed for a given track. In a second step 320 of the method, a command is forwarded from the microcontroller 314 to the servo processor 218 to instruct the servo processor to perform a read operation at a specified spin rate i. In typical applications i may be an index into an array of control parameters employed by the servo processor 218. In a decision step 330 of the method, a function f(ER,S) is computed and compared to a threshold value T. While decision step 330 employs a greater than comparison, any other comparison such as less than, equal to, greater than or equal to, or the like may be used, depending on the implementation. The function f(ER,S) is an arbitrary function that may be tuned to the specific system needs. The first argument, ER, corresponds to a detected error rate from any or all of the ECC processing levels employed within the system. The second optional argument of this function, S, corresponds state variable information maintained in the system as described above in connection with the function I(S). As indicated by the outputs of the decision step 330, if the f(ER,S) is above a threshold value T, control is passed to a step 340 where the speed parameter is modified according to i=i+J(ER,S). Here an arbitrary function J(ER,S) is a used which determines how to modify the speed given the reported error rate, ER, and any state information, S, deemed useful in the system as described above. After the speed parameter is modified in the step 340, control is passed back to the step 320 which passes, for example, read command and the modified speed parameter, i, to the servo controller 218. If the decision step 330 evaluates to false, then the received data is deemed to be acceptable and control is passed to a step 350 wherein the data is written to the output buffer.

In the method 300, the functions I, f, and J are arbitrary functions. Thus one or both arguments of each function are optional. For example, one could set J(ER,S)=−1, so that every time the condition 330 evaluates to true, the spin-speed decremented by one interval. Note that the parameter i may be an index into a speed array. For example, the first unit decrement may move the speed from 32X to 16X while the second unit decrement may move the speed from 16X to 12X. Also, as I, f, and J are defined as arbitrary functions whose arguments may include state variables, these functions may be implemented via sequential logic. That is, any sequence of program steps used to generate these numbers may be used to implement the functions I, f, and J. For example, subroutines implementing any or all of combinational logic, sequential if-then logic, and fuzzy logic are anticipated. Also, as illustrated in the example below, other steps and decision logic may be incorporated into the method 200 without departing from its scope.

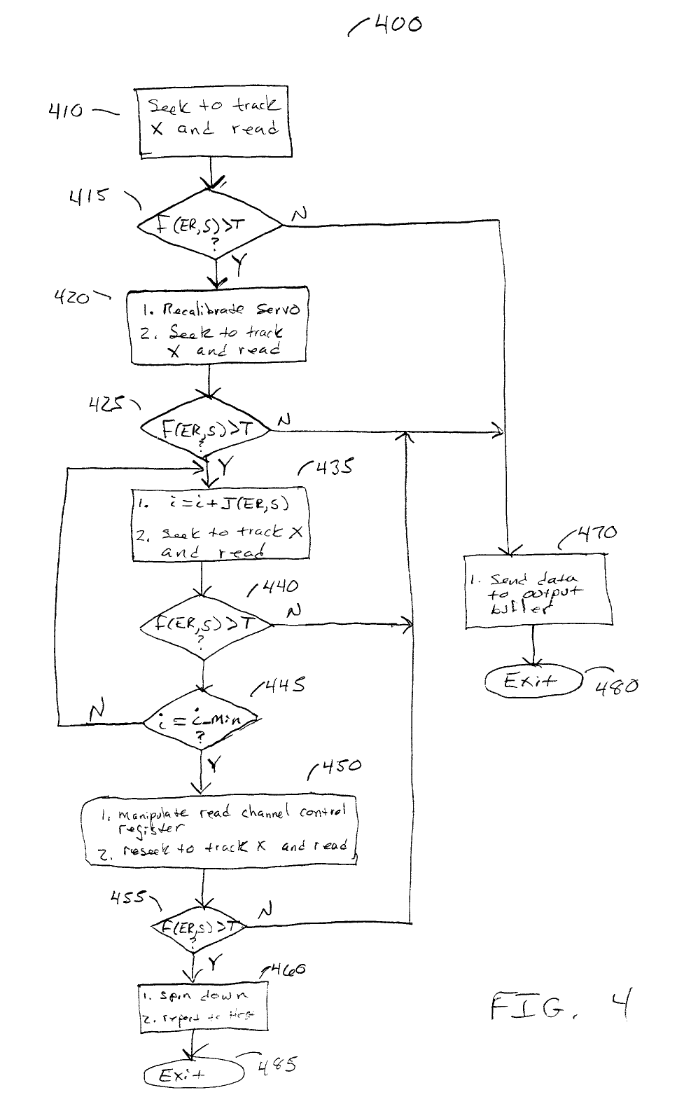

FIG. 4 illustrates a particular embodiment of the method 300 as implemented within an optical disk system in accordance with a preferred embodiment of the present invention. This method will be described in connection with the media-read processor 200, however the method may be applied in systems with modified hardware architectures and in other related systems involving other forms of media and read/write-channels. A first step 410 commands the system to move the laser to a selected track designated as track X and to read the data encoded thereon. During the read operation, an error rate parameter ER is generated to report the quality of the read data based on the ECC processing described in connection with FIG. 2. A decision step 415 checks the ER value by comparing the function f(ER,S) against a threshold T. As described in connection with FIG. 3, various types of compare operations may be used in any of the decision diamonds of the method 400 without departing from the scope of the method.

In this disclosed example, if the error rate is below the threshold, T, control passes to a step 470 where the data is sent to the output buffer and algorithm is terminated in an exit path 480. If the ER value is deemed to be too high, control is passed to a step 420 where the servo mechanism is recalibrated, the laser is moved back to track X, and a read operation is attempted once more. A new value of ER is thus obtained based on the ECC processing of the read data of the step 420. This value is checked in a decision step 425 which may optionally use a decision function different from the one used in the step 415. If the comparison 425 evaluates to false, the read data is deemed to be of sufficient quality and control passes to the step 470 and subsequently onto the exit path 480 as previously described. If the comparison 425 evaluates to true, the data is deemed to be of insufficient quality and control is passed to a step 435. In the step 435 the speed is modified as discussed in connection with 340 FIG. 3. In this example, the function J(ER,S) is chosen to be a decrement of one unit so that the speed is lowered to the next lower level.

Next, step 435 initiates re-seek to track X and a re-read operations. A new value of ER is generated by the ECC processing circuits during the read operation commanded in the step 435. This new ER value corresponding to the read data at the lower speed is checked in a step 440 against a threshold. The function, f, in step 440 may optionally be set to be different from those of steps 415 and 425. If the comparison evaluates to false, the read data is deemed to be of sufficient quality and control passes to the step 470 subsequently to the exit path 480 as previously described. If the comparison evaluates to true, the data is deemed to be of insufficient quality and control is passed to a second decision step 445 which checks an end condition to see if the speed has been decremented to the lowest possible value. If the end condition is false, control loops back from decision step 445 to the step 435 wherein the same process is repeated. If the end condition of step 445 evaluates to true, control passes to a step 450 where settings in the read channel control register are manipulated, a re-seek operation is performed, and the information track X is re-read.

After the read of the step 450, control passes to a decision step 455 which checks an ER value generated in the read operation of the step 450 to check the quality of the read data. The function, f, in the decision step 455 may optionally be set to be different from those of steps 415, 425 and 440. If the comparison 455 evaluates to false, the read data is deemed to be of sufficient quality and control passes to steps 470 and 480 as previously described. If the comparison evaluates to true, indicating the data is still of insufficient quality, control is passed to a step 460. In the step 460, a command is issued which causes the servo to “spin down” meaning the drive is put in an inactive state where the disk is at rest. Next the step 460 reports the no-read event to the host processor, for example using the system interface 216. After the step 460, the method 400 is exited in block 485.

It should be noted that the method illustrated in FIG. 4 may serve a component within higher level control algorithms. For example, a read-error control algorithm may applied to ensure that successive tracks continue to be read reliably by monitoring the ER values for read each track. As long as the ER values are below a threshold, reading may continue. In this example, when an ER value is detected above a threshold the higher level read-control algorithm will fork control to block 410 as the entry point to apply the method 400. In a seek-error control algorithm the block 410 may be entered upon each new seek wherein only the track header information may be needed to confirm the seek. Once the seek has been confirmed and a speed has been set, control may fork back to the higher level read algorithm which will only fork to block 410 if a read-error is detected while attempting to read the information after the confirmed seek operation.

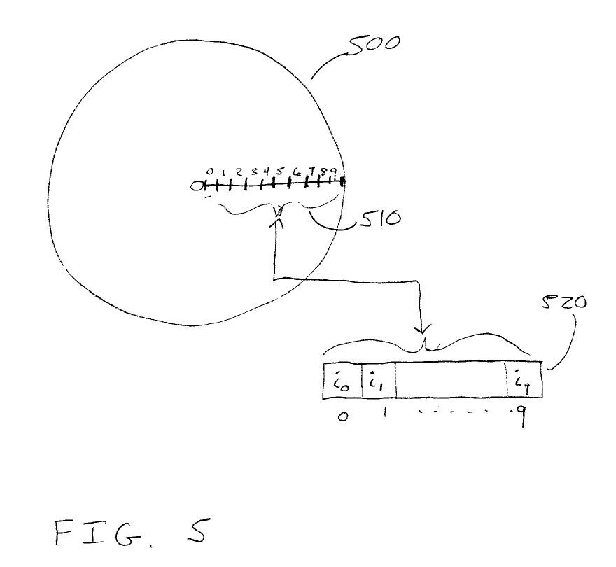

FIG. 5 is a diagram illustrating a radial speed map of a disk according to an aspect of the present invention. Here a disk 500 is segmented radially into N radial bands whose widths may be defined in various ways. In FIG. 5, an embodiment wherein the disk 500 is partitioned into ten equal-radius bands is illustrated by way of example. In this example, the ten equal-radius bands are enumerated from zero to nine as indicated by a line segment 510. A speed map 520 consists of an array of numbers each of which preferably corresponds to the highest speed at which data may be reliably read from an associated band on the disk 500. As illustrated in FIG. 5, radial band labeled zero has an associated entry i0 in the speed map 520. This value i0 is the speed determined, for example, by applying the method 400 to selected tracks within band zero. Similarly, the other bands each have corresponding entries in the speed map array 520. By maintaining a speed map, the initial speed estimate as computed in step 310 of method 300 may be read out of the speed map array as a function of the radial distance from the information track to the center of the medium. This speed map may also be incorporated into the method 400 by initializing the speed in the step 410 to the value stored in the speed map array 520. The speed map allows the system to take advantage of the fact that imbalance effects do not inhibit reading equally at all radial distances. For example, in CD-ROMs, the information at the outer edge of an imbalanced disk is more severely affected than the data near the center.

Although the present invention has been described with reference to a specific embodiment, other embodiments may occur to those skilled in the art without deviating from the intended scope. For example, in an alternate embodiment, the media-read processor 200 may be redesigned to operate with a spinning magnetic medium in which case the laser and photo diode circuits are replaced by magnetic related circuits. Also, while the media-read processor 200 focuses on the read operation, a similar system with write capabilities is anticipated. Also, various blocks of the media-read processor 200 may be merged or distributed. For example some of the functionality of the microcontroller 214 may be moved into the servo processor 218. As discussed in connection with the method 300, the method 400 may be modified and similar methods may be constructed to increase the read speed, for example if error rates are below specified thresholds. That is, the comparison blocks in FIG. 4 may be modified to test multiple conditions such as if f(ER,S) is below a first threshold and above a second threshold. Also, as illustrated by the difference between FIG. 3 and FIG. 4, various other steps and control structures may be added without deviating from the scope of the present invention. For example the step 450 may be replaced by a loop that modifies multiple settings in the read channel control register and checks the error condition for these multiple settings. Therefore, it is to be understood that the invention herein encompasses all such embodiments which do not depart from the spirit and scope of the invention as defined in the appended claims.

What is claimed is:

1. An method of altering a spin rate of a rotating medium comprising the steps of:
(a) detecting a read error; and
(b) altering the spin rate of said rotating medium in response to said read error.

2. The method of claim 1 wherein said read error corresponds to a read error rate (ER) indication derived from an ECC code embedded into an information stream stored on said rotating medium.

3. The method of claim 1 wherein an initial spin rate is determined for a given information track using data stored in a data structure.

4. The method of claim 1 wherein step (b) comprises reducing the read speed.

5. The method of claim 1 wherein step (b) comprises computing a function of said read error to determine a value with which to use to alter the spin rate.

6. The method of claim 1 wherein step (b) comprises comparing said read error to a first threshold and a second threshold.

7. The method of claim 6 wherein step (b) further comprises lowering the spin rate if the first threshold is exceeded, leaving the spin rate the same if the read error is between the first threshold and the second threshold, and lowering the spin rate if the read error is below the second threshold.

8. The method of claim 1 wherein step (a) comprises seeking to a designated track X prior to detecting said read error.

9. The method of claim 8 wherein step (a) further comprises reading a track header information to confirm a seek operation and to use the track header information to detect the read error.

10. A method of mapping a rotating medium comprising the steps of:
(a) determining a highest spin rate at which information may be read from a given portion of said rotating medium;
(b) storing a parameter indicative of the highest spin rate in a data structure.

11. The method of claim 10 wherein the data structure comprises a plurality of entries,and wherein a selected entry corresponds to a designated portion of the rotating medium, and wherein the selected entry includes the parameter indicative of the highest spin rate

12. The method of claim 11 wherein said data structure includes an entry for each portion of said rotating medium.

13. The method of claim 10 wherein said rotating medium is an optical disk.

14. An apparatus comprising:
a servo processor which controls the spin rate of a rotating medium;
a microcontroller which executes a control algorithm used to control the reading of information from said rotating storage medium; and
a decoder processor which processes a received signal obtained from said rotating medium to recover a digital bit stream therefrom, said decoder processor further performing an ECC decoding to correct errors in said bit stream and to detect read errors therein;
wherein said decoder processor forwards information related to said read errors in said digital bit stream to said microcontroller, and wherein said microcontroller uses said information to determine whether to change spin rate of said rotating storage medium, and if said microcontroller determines a change in said spin rate is needed, said microcontroller commands to said servo processor to change said spin rate.

15. The apparatus according to claim 14 wherein said microcontroller and said servo processor are implemented as a separate processing subsystem.

16. The apparatus according to claim 14 wherein said rotating medium is an optical disk.

17. The apparatus according to claim 16 wherein said received signal obtained from said rotating medium comprises a photo diode array signal as received from a laser-illuminated optical disk and as preprocessed by a read channel processing circuit.

18. The apparatus according to claim 16 wherein said servo processor sends control signals to a laser and a set of actuators used to position said laser and to spin said optical disk.

19. The apparatus according to claim 16 wherein said microcontroller commands said servo processor to spin said optical disk at a set of prespecified rates, each of said rates being a multiple of a reference rate.

20. A computer system comprising:
a host processor;
a bulk storage unit comprising a rotating medium controller and a physical rotating medium enclosure; and a system level interface coupling said host processor to said rotating medium controller;
wherein said rotating medium controller comprises the apparatus comprising:
(i) a servo processor which controls the spin rate of a rotating medium;
(ii) a microcontroller which executes a control algorithm used to control the reading of information from said rotating storage medium; and
(iii) a decoder processor which processes a received signal obtained from said rotating medium to recover a digital bit stream therefrom, said decoder processor further performing an ECC decoding to correct errors in said bit stream and to detect read errors therein.
